(19) United States
(12) Patent Application Publication
(10) Pub. No.: US 2011/0043720 A1
(43) Pub. Date: Feb. 24, 2011

(54) METHOD FOR MANUFACTURING DISPLAY DEVICE AND DISPLAY DEVICE

(75) Inventors: Tohru Okabe, Osaka-shi (JP); Yoshimasa Chikama, Osaka-shi (JP); Yohsuke Kanzaki, Osaka-shi (JP); Yuya Nakano, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/672,740

(22) PCT Filed: Jul. 4, 2008
(86) PCT No.: PCT/JP2008/001784

§ 371 Date: Feb. 9, 2010

(30) Foreign Application Priority Data
Nov. 19, 2007 (JP) 2007-299082

(51) Int. Cl. G02F 1/1333; G02F 1/1339

(52) U.S. Cl. 349/58; 349/190

(57) ABSTRACT

A method for manufacturing a display device includes; a first step of preparing a plastic substrate placed on a support substrate, a second step of bonding a first region of an expanded silicone sheet to an end of the plastic substrate, and bonding a second region of the silicone sheet to the support substrate having the plastic substrate placed thereon, thereby fixing the plastic substrate to the support substrate by a biasing force of the silicone sheet, and a third step of laminating a plurality of thin films over the plastic substrate fixed to the support substrate.

### BACKGROUND OF THE INVENTION

1. Field of the Invention

The present invention relates to methods for manufacturing a display device, and display devices.

2. Description of the Related Art

Conventionally, attempts have been made to manufacture high-performance thin film devices such as transistors and sensors by using flexible substrates such as plastic and a metal thin film, instead of hard substrates such as glass and silicon. In particular, plastic substrates have received a lot of attention as substrates for use in next generation displays, due to their transparency and durability. However, the plastic substrates are characterized by being thin and easily bent, as compared to glass substrates and silicon substrates, and it is very difficult to carry the plastic substrates.

As a solution to these problems with the plastic substrates, Japanese Published Patent Application No. 2000-241822, for example, discloses a method for manufacturing a liquid crystal panel. In this method, one plastic substrate is bonded to a support body via an adhesive layer, which has a property that its adhesive strength is reduced by a later operation. Then, the plastic substrate bonded to the support body is bonded to the other substrate via a sealant to form a liquid crystal cell. The adhesion of the adhesive layer is reduced by a later operation after or simultaneously with curing of the sealant. Subsequently, the liquid crystal cell is delaminated from the support body. Japanese Published Patent Application No. 2000-241822 describes that this method enables an assembly operation to be performed in the state where the plastic substrate, which is easily bent, is fixed to the support body, until the step of assembling the liquid crystal cell, thereby facilitating manufacturing, and enabling high accuracy liquid crystal cell structures to be obtained.

However, the plastic substrates also have a major characteristic that the dimensions of the substrate are significantly changed by moisture and heating. Thus, when the periphery of a plastic substrate 101 is bonded to a support substrate 100 with adhesive means 102 as shown in, e.g., FIG. 8, there is no problem at room temperature or in a dry state, but heating the substrate, or processing the substrate under conditions of high humidity increases the dimensions of the substrate. This causes bending of the plastic substrate 101. Moreover, manufacturing of thin film devices typically requires a process of forming a high-performance thin film under high temperature conditions of 200° C. or higher. Thus, such bending of the substrate tends to occur during manufacturing of thin film devices. This bending of the substrate causes non-uniform quality of thin films, presenting a major problem of reduced performance of the thin film devices to be manufactured.

Moreover, such a change in dimensions of the substrate during the manufacturing process tends to generate static electricity on the plastic substrate. This static electricity not only destabilizes quality of films to be formed, and etching due to discharge instability during a vacuum discharge such as sputtering, chemical vapor deposition (CVD), and dry etching, but also creates the possibility that the device itself is completely damaged by an abnormal discharge.

### SUMMARY OF THE INVENTION

The present invention was developed in view of the above problems, and preferred embodiments of the present invention provide a method for manufacturing a display device, which is capable of forming a high-performance thin film laminated device over a plastic substrate with satisfactory manufacturing efficiency at satisfactory manufacturing cost, and a display device.

A method for manufacturing a display device according to a preferred embodiment of the present invention includes a first step of preparing a plastic substrate placed on a support substrate; a second step of bonding one region of an expanded elastic member to an end of the plastic substrate placed on the support substrate, and bonding the other region of the elastic member to the support substrate having the plastic substrate placed thereon, thereby fixing the plastic substrate to the support substrate by a biasing force of the elastic member; and a third step of laminating a plurality of thin films over the plastic substrate fixed to the support substrate.

With this configuration, since the end of the plastic substrate is preferably fixed to the support substrate by the biasing force of the elastic member, excellent flatness of the plastic substrate can be ensured even in the step of laminating thin films, which requires a high temperature treatment, or a treatment with a chemical or the like. This can satisfactorily reduce the problem of non-uniform quality of the thin films, which is caused by bending of the substrate and a change in dimensions of the substrate. Moreover, uniformly controlling a change in dimensions of the plastic substrate can reduce generation of static electricity, whereby the quality of the films to be formed and etching can be stabilized. Moreover, a normal apparatus that merely includes the support substrate can be used as it is to process the plastic substrate that is easily bent. Thus, a high-performance thin film laminated device can be formed over the plastic substrate with satisfactory manufacturing efficiency at satisfactory manufacturing cost.

According to the method of a preferred embodiment of the present invention, the elastic member may have a hardness of about 60° or less as measured by a type A durometer as specified in JIS K 6253.

With this configuration, since the hardness of the elastic member preferably is about 60° or less as measured by a type A durometer as specified in JIS K 6253, the plastic substrate can be processed while being pulled with a weak force. Thus, the plastic substrate can always be processed in a flat state without being broken, whereby the quality of the display device is improved.

According to the method of a preferred embodiment of the present invention, in the second step, the elastic member may be expanded by heating.

With this configuration, since the elastic member preferably is expanded by heating, the elastic member can be expanded by using a manufacturing apparatus having a simple structure, whereby the manufacturing cost is reduced.

According to the method of a preferred embodiment of the present invention, in the second step, the plastic substrate and the support substrate may also be expanded by heating to the same temperature as that of the elastic member, and in this state, the other region of the elastic member may be fixed to the support substrate.

With this configuration, not only the elastic member but also the plastic substrate and the support substrate are heated and expanded at the same temperature. Thus, the elastic member, which has a large thermal expansion coefficient and a thin thickness, and the plastic substrate can be easily and uniformly expanded. This increases bonding accuracy of the elastic member to the plastic substrate.

According to the method of a preferred embodiment of the present invention, in the second step, the elastic member may be heated at a temperature equal to or higher than a highest temperature at which the plastic substrate is heated when the plurality of thin films are laminated in the third step.

With this configuration, the elastic member is heated at a temperature equal to or higher than the highest temperature of the plastic substrate. Thus, flatness of the plastic substrate can be satisfactorily ensured even in the step of laminating thin films, which typically requires a high temperature treatment. This enables thin films having a satisfactorily uniform thickness to be laminated.

According to the method of a preferred embodiment of the present invention, in the first step, a treatment for reducing friction may have been performed on a surface of the support substrate, which faces the plastic substrate, and/or a surface of the plastic substrate, which faces the support substrate.

With this configuration, since the treatment for reducing friction preferably has been performed on the contact surface between the support substrate and the plastic substrate, the heated plastic substrate can smoothly expand and contract on the support substrate. Thus, the plastic substrate can always be processed in a flat state, whereby the quality of the display device is improved.

According to the method of a preferred embodiment of the present invention, the treatment for reducing friction, which has been performed on the support substrate, may be a process of forming a concavo-convex pattern in which a difference in height between a concave portion and a convex portion is about 1 μm to about 10 μm, for example.

With this configuration, a change in dimensions of the plastic substrate, which is caused by a change in temperature thereof, is especially easily facilitated without processing the plastic substrate. Moreover, forming the concavo-convex pattern, in which a difference in height between a concave portion and a convex portion is about 1 μm to about 10 μm, for example, on the surface of the support substrate reduces formation of concaves and convexes or stepped portions on the surface of the plastic substrate, whereby the quality of the display device is improved.

According to the method of a preferred embodiment of the present invention, the treatment for reducing friction may be a process of forming an inorganic film.

With this configuration, since the treatment for reducing friction preferably is a process of forming an inorganic film, a change in dimensions of the plastic substrate, which is caused by a change in temperature of the plastic substrate and absorption of water by the plastic substrate during the manufacturing process, is especially facilitated, whereby the quality of the display device is improved.

According to the method of a preferred embodiment of the present invention, the treatment for reducing friction may be a process of forming a concavo-convex pattern by photolithography.

With this configuration, since the treatment for reducing friction preferably is a process of forming a fine concavo-convex pattern by photolithography, a change in dimensions of the plastic substrate, which is caused by a change in temperature of the plastic substrate and absorption of water by the plastic substrate during the manufacturing process, is especially facilitated, whereby the quality of the display device is improved.

According to the method of a preferred embodiment of the present invention, the treatment for reducing friction may be a process of applying a low friction material.

With this configuration, since the treatment for reducing friction preferably is a process of applying a low friction material, a change in dimensions of the plastic substrate, which is caused by a change in temperature of the plastic substrate and absorption of water by the plastic substrate during the manufacturing process, is especially facilitated, whereby the quality of the display device is improved.

According to the method of a preferred embodiment of the present invention, in the first step, a treatment for reducing static electricity may have been performed on a surface of the support substrate, which faces the plastic substrate, and/or a surface of the plastic substrate, which faces the support substrate.

With this configuration, since the treatment for reducing static electricity preferably has been performed on the contact surface between the support substrate and the plastic substrate, generation of static electricity can be satisfactorily prevented when the dimensions of the plastic substrate change due to a change in temperature thereof. Thus, the manufacturing yield of the display device can be increased.

According to the method of a preferred embodiment of the present invention, the treatment for reducing static electricity may be a process of forming a conductive film.

With this configuration, since the treatment for reducing static electricity preferably is a process of forming a conductive film, static electricity, which is generated on the contact surface between the support substrate and the plastic substrate, can be reduced by dispersing the static electricity.

According to a method of a preferred embodiment of the present invention, the conductive film may be formed by a transparent conductive member.

With this configuration, since the conductive film preferably is formed by a transparent conductive member, a back exposure process can be performed on the plastic substrate, and a transparent device can be fabricated.

According to the method of a preferred embodiment of the present invention, the transparent conductive member may be made of ITO or IZO. ITO (Indium Tin Oxide) is a compound of indium oxide and tin oxide, and IZO (Indium Zinc Oxide) is a compound of indium oxide and zinc oxide.

With this configuration, since the transparent conductive member preferably is made of ITO or IZO, which is highly transparent to visible light and is satisfactorily conductive, the back exposure process can be performed more satisfactorily, and a transparent device can be fabricated.

The method of a preferred embodiment of the present invention may further include a fourth step of cutting off an end of the plastic substrate, to which one region of the elastic member has been bonded, by laser light radiation or the like after the plurality of thin films are laminated over the plastic substrate in the third step.

With this configuration, the method preferably further includes the fourth step of cutting off an end of the plastic substrate, to which one region of the elastic member has been bonded, by laser light radiation or the like after the plurality of thin films are laminated over the plastic substrate in the third step. Thus, an unnecessary end of the plastic substrate, to which the elastic member has been bonded, can be easily and reliably cut off.

A display device according to yet another preferred embodiment of the present invention is manufactured by the method described above.

With this configuration, since the display device is preferably manufactured by the method described above, a high-performance thin film laminated device can be formed over the plastic substrate with satisfactory manufacturing efficiency at satisfactory manufacturing cost.

Various preferred embodiments of the present invention provide a method for manufacturing a display device, which is capable of forming a high-performance thin film laminated device over a plastic substrate with satisfactory manufacturing efficiency at satisfactory manufacturing cost, and a display device.

Other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a cross-sectional view of a liquid crystal display device.

FIG. 2 is a cross-sectional view of an active matrix substrate.

FIG. 3 is a cross-sectional view of a counter substrate.

FIG. 4 is a schematic view of a hot plate disposed in a vacuum chamber.

FIG. 5 is a cross-sectional view of a plastic substrate placed on a support substrate in a first step.

FIG. 6 is a cross-sectional view of the plastic substrate fixed to the support substrate with a silicone sheet in a second step.

FIG. 7 is a cross-sectional view of the plastic substrate in which an end of the plastic substrate, which has the silicone sheet bonded thereto, has been cut off in a fourth step.

FIG. 8 is a cross-sectional view of a conventional plastic substrate fixed to a support substrate.

### DETAILED DESCRIPTION OF THE PREFERRED EMBODIMENTS

The configuration of a display device and a manufacturing method thereof according to preferred embodiments of the present invention will be described in detail below with reference to the accompanying drawings. Note that the present invention is not limited to the following preferred embodiments. In the present preferred embodiments, a liquid crystal display (LCD) device will be described as an example of the display device.

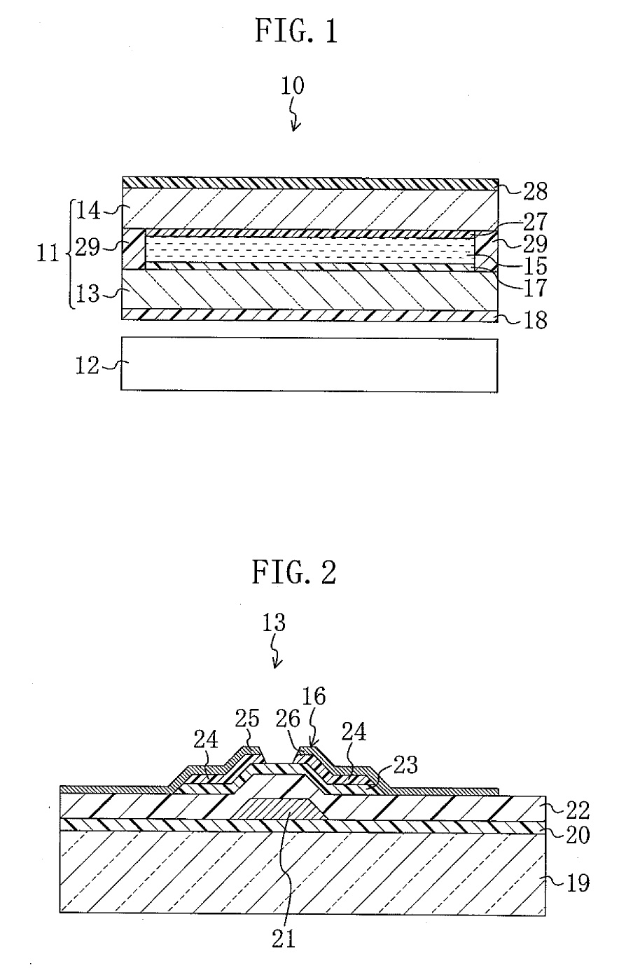

FIG. 1 is a cross-sectional view of an LCD device 10 according to a preferred embodiment of the present invention. The LCD device 10 includes an LCD panel 11 and a backlight 12.

The LCD device 10 includes an active matrix substrate and a counter substrate 14, each of which is a thin film laminated device formed by laminating a plurality of thin films over a plastic substrate. The LCD device 10 includes a liquid crystal layer 15 located between the active matrix substrate 13 and the counter substrate 14.

FIG. 2 is a cross-sectional view of the active matrix substrate 13. A plurality of pixels (not shown) are provided on the active matrix substrate 13, and a thin film transistor (a TFT 16) is formed at each pixel. An alignment film 17 is provided over the surface located on the liquid crystal layer 15 side of the active matrix substrate 13, and a polarizer 18 is provided over the surface located on the side opposite to the liquid crystal layer 15 side of the active matrix substrate 13.

The active matrix substrate 13 is preferably defined by a plastic substrate 19 having a thickness of, e.g., about 0.1 mm. The plastic substrate 19 is preferably made of, e.g., at least one of an epoxy resin, a polyethylene terephthalate (PET) resin, a polyether sulfone (PES) resin, a polyimide resin, polyester, polycarbonate, an acrylic resin, and the like. The plastic substrate 19 may be any substrate that exhibits flexibility, and may be a composite plastic substrate containing a glass component or the like. A SiNx film 20, which has a thickness of about 150 nm or the like, is formed as, e.g., a basecoat on one surface of the plastic substrate 19. A gate electrode 21, which is made of, e.g., Ti or the like, is formed with a thickness of about 200 nm at each pixel (not shown) on a portion of the SiNx film 20. A gate insulating film 22, which is made of, e.g., a SiNx layer or the like, is formed with a thickness of about 400 nm so as to cover the SiNx film 20 and the gate electrode 21.

A semiconductor layer 23 is formed with a thickness of, e.g., about 150 nm on the gate insulating film 22 so as to cover the entire gate electrode 21 with the gate insulating film 22 interposed therebetween. The semiconductor layer 23 is made of, e.g., at least one of amorphous Si (a-Si), polycrystalline Si, microcrystalline Si, and an oxide semiconductor, and the like.

An n-semiconductor layer 24, which is a layer highly doped with n-type impurities, is formed with a thickness of, e.g., about 50 nm on the semiconductor layer 23. A source electrode 25 and a drain electrode 26, which are made of, e.g., Ti or the like, are formed with a thickness of about 200 nm on the n+ semiconductor layer 24 and the gate insulating film 22. TFTs 16, each having the gate electrode 21, the source electrode 25, and the drain electrode 26, are formed over the active matrix substrate 13.

The TFTs 16 are covered by a protective layer, not shown, which is made of, e.g., a SiNx layer or the like. Pixel electrodes, not shown, which respectively form the pixels, are formed on the drain electrodes 26, respectively. The drain electrodes 26 and the pixel electrodes are electrically connected to each other, respectively.

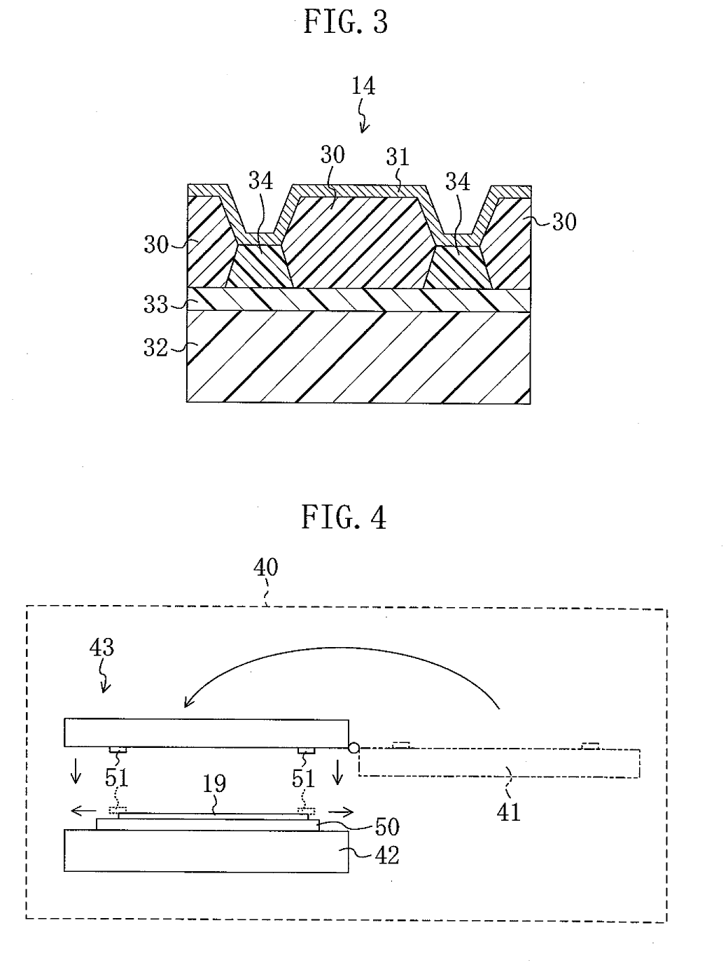

As shown in FIG. 3, the counter electrode 14 is formed by a plastic substrate 32. A SiNx film 33, which has a thickness of, for example, 150 nm, is formed as, e.g., a basecoat on the plastic substrate 32. A plurality of color filter layers 30, which respectively form the pixels, are formed at predetermined intervals on the SiNx film 33. A black matrix layer 34, which separates the plurality of color filter layers 30 from each other, is formed between adjacent ones of the color filter layers 30, and a counter electrode 31 is formed so as to cover the color filter layers 30 and the black matrix layer 34. An alignment film 27 is provided on the surface located on the liquid crystal layer 15 side of the counter substrate 14, and a polarizer 28 is provided on the surface located on the side opposite to the liquid crystal layer 15 side of the counter substrate 14.

The liquid crystal layer 15 is sealed by a sealant 29 formed between the active matrix substrate 13 and the counter substrate 14. Columnar spacers (not shown), which are made of, e.g., plastic, glass, or the like, are formed between the active matrix substrate 13 and the counter substrate 14 in order to maintain a uniform cell gap between the substrates 13, 14.

A method for manufacturing the LCD device 10 according to a preferred embodiment of the present invention will be described in detail below with reference to the figures.

First, a process of forming the active matrix substrate will be described. The process of forming the active matrix substrate includes first to fourth steps.

First, as the first step, as shown in FIG. 4, a vacuum chamber 40 is prepared, and a hot plate 43 having upper and lower plates 41, 42 is disposed in the vacuum chamber 40. The upper plate 41 is configured so as to face the lower plate 42 when inverted. The surface of the plate 41 needs to expand uniformly when heating a silicone sheet 51 having a thermal expansion coefficient of about 500 ppm/° C., which is significantly larger than that of a support substrate 50 and the plastic substrate 19. Thus, it is preferable that the plate 41 be formed so as to have reduced friction by providing a concavo-convex pattern, a material having a low friction coefficient, or the like, or that the plate 41 be made of a material having a thermal expansion coefficient equal to that of the silicone sheet 51.

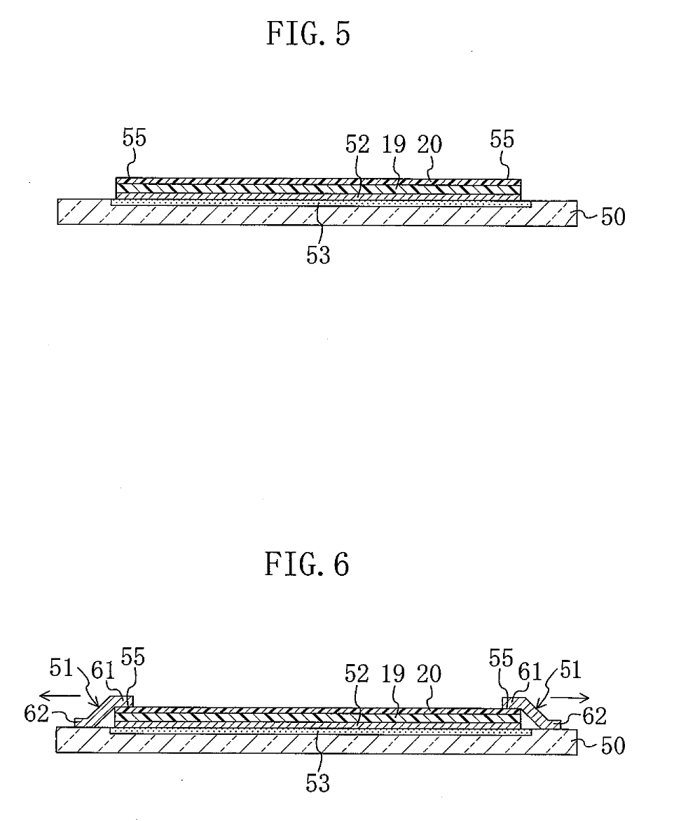

Then, the support substrate 50 is positioned on the lower plate 42 of the hot plate 43, and the plastic substrate 19 is placed on the support substrate 50. As shown in FIG. 5, the SiNx film 20 as a basecoat has been formed on the front surface of the plastic substrate 19, and an ITO film 52 for static protection has been formed on the back surface of the plastic substrate 19, each with a thickness of, e.g., about 200 nm. A plastic substrate, having, e.g., a size of about 320×420 mm and a thickness of about 0.1 mm, is prepared as the plastic substrate 19. A concavo-convex pattern 53 has been formed, by polishing, on the surface of the support substrate 50, which faces the plastic substrate 19, in order to facilitate sliding of the plastic substrate 19 when the dimensions thereof change. The concavo-convex pattern 53 is formed so that the difference in height between a convex portion and a concave portion is, e.g., about 1 μm to about 10 μm. A glass substrate, having, e.g., a size of about 360 mm×465 mm and a thickness of about 0.7 mm, is used as the support substrate 50.

Note that, to facilitate sliding of the plastic substrate 19 when the dimensions thereof change, fine patterning may be performed on the support substrate 50 by photolithography in order to reduce the contact area with the plastic substrate 19. Alternatively, a film of an inorganic material having a low friction coefficient may be formed on, or applied to the support substrate 50. The present invention is not limited to the inorganic material, and a film of an organic material such as a silicone resin or a Teflon (registered trademark) resin may be formed on, or applied to the support substrate 50.

Then, the process proceeds to the second step, where the silicone sheet 51 formed in a frame shape is positioned on the surface of the upper plate 41, which faces the lower plate 42. An opening of the silicone sheet 51 has a size of about 310 mm×410 mm, for example. The silicone sheet 51 is positioned so as to correspond to an end 55 of the four sides of the plastic substrate 19 placed over the lower plate 42. That is, the silicone sheet 51 is positioned so that one region 61 of each side of the frame-shaped silicone sheet 51 corresponds to the end of the plastic substrate 19, and the other region 62 corresponds to the support substrate 50. It is preferable that the silicone sheet 51 have a hardness of 60° or less as measured by a type A durometer as specified in Japanese Industrial Standard (JIS) K 6253.

Then, the upper and lower plates 41, 42 are heated to about 250° C. so that the support substrate 50, the plastic substrate 19, and the silicone sheet 51 are heated to the same temperature and expanded. The highest temperature in a later step of laminating a plurality of thin films over the plastic substrate 19 is about 200° C. Thus, the upper and lower plates 41, are heated to about 250° C. in the above step in order to initially heat the support substrate 50, the plastic substrate 19, and the silicone sheet 51 to a temperature equal to or higher than this highest temperature.

With all of the support substrate 50, the plastic substrate 19, and the silicone sheet 51 being sufficiently expanded by heating, the silicone sheet 51 and the support substrate 50 are respectively fixed to the upper and lower plates 41, 42 by an electrostatic chuck, a vacuum holding method, or the like.

Then, the upper plate 41 is inverted, and is accurately positioned above the lower plate 42. Then, the vacuum chamber 40 is sufficiently evacuated, and the upper plate 41 is moved downward onto the lower plate 42. After the upper plate 41 is moved downward onto the lower plate 42, the silicone sheet 51 is bonded and fixed to the support substrate 50 and the plastic substrate 19 as the support substrate 50, the plastic substrate 19, and the silicone sheet 51 are entirely heated. Then, after the temperature is allowed to go down to normal temperature, the vacuum chamber 40 is opened to the atmosphere, and the support substrate 50 having the plastic substrate 19 fixed thereto is taken out of the vacuum chamber 40. Bonding the substrates under vacuum in this manner is preferable because the possibility that air is introduced between the support substrate 50 and the plastic substrate 19 is reduced.

FIG. 6 is a cross-sectional view of the plastic substrate 19 fixed to the support substrate 50 by the silicone sheet 51. As shown in the figure, a contraction force is generated when the silicone sheet 51 as an elastic material cools down to room temperature. This contraction force serves as a biasing force that is applied in the direction shown by arrows in the figure. This force uniformly pulls the plastic substrate 19 from all directions, whereby the plastic substrate 19 can be stably fixed to the support substrate 50. Thus, the plastic substrate 19, which tends to be bent significantly, can be kept flat.

Then, the process proceeds to the third step. First, a Ti film is formed with a thickness of about 200 nm by a sputtering method over the plastic substrate 19 that is fixed to the support substrate 50 by the elastic member. The Ti film is patterned by a photolithography method to form the gate electrode 21. Then, a SiN film (400 nm), an a-Si layer (150 nm), and an n+ Si layer (50 nm) are continuously formed by a CVD method at a temperature as high as 250° C. as the gate insulating film 22, the semiconductor layer 23, and the n+ semiconductor layer 24, respectively. The a-Si layer and the n+ Si layer are patterned by a photolithography method. Then, a Ti film is formed with a thickness of about 200 nm by a sputtering method, and is patterned by a photolithography method to form the source electrode 25 and the drain electrode 26. Then, the n+ Si layer in the channel portion of the TFT 16 is removed by a dry etching method, thereby fabricating the TFT 16 over the plastic substrate 19. Since the plastic substrate 19 has been bonded to the glass substrate that is the support substrate 50, an apparatus similar to that used for glass substrates can be used to form thin films.

In the third step of forming thin films as well, the temperature of the silicone sheet 51 as an elastic material does not increase to a value equal to or higher than the initial temperature condition (250° C.), but merely decreases. Thus, a contraction force is generated as the silicone sheet 51 is restored from the expanded state to its original state. This contraction force serves as a biasing force, which uniformly pulls the plastic substrate 19 from all directions, whereby the plastic substrate 19 can be fixed to the support substrate 50. Thus, a plurality of thin films can be accurately formed while keeping flat the plastic substrate 19 that tends to be bent significantly. Moreover, since the periphery of the plastic substrate 19 is completely covered by the silicone sheet 51, the plastic substrate 19 can be carried and subjected to a wet process. Thus, the plastic substrate 19 can be carried and processed in a flat state in all the processes of manufacturing a thin film laminated device.

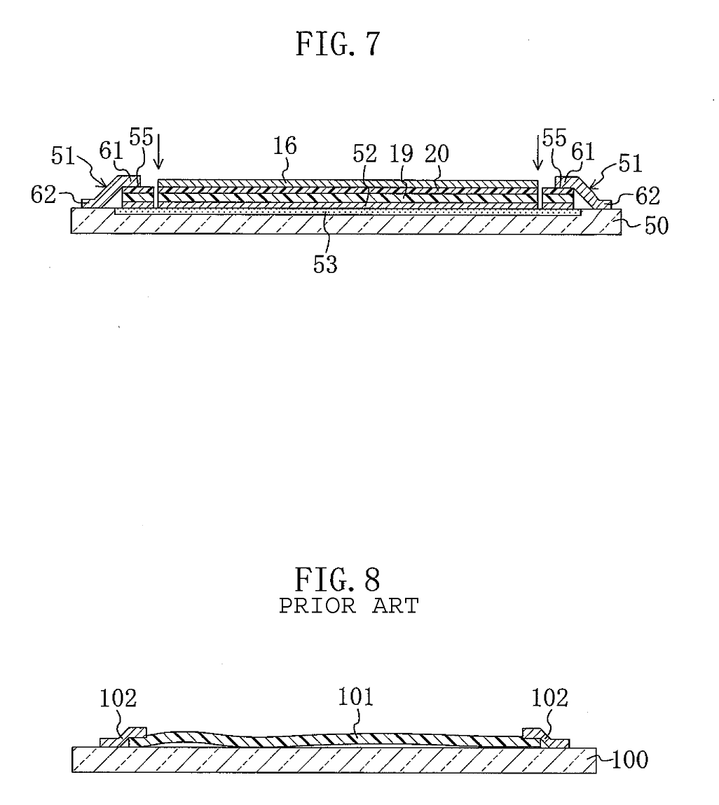

Then, the process proceeds to the fourth step. As shown in FIG. 7, the end 55 of the plastic substrate 19, to which the silicone sheet 51 has been bonded, is cut off by laser light radiation or dicing to separate the active matrix substrate 13 from the support substrate 50. The arrows in the figure indicate a portion to be irradiated with laser light.

A process of forming the counter substrate will be described below. First, as in the process of forming the active matrix substrate, the plastic substrate 32 is positioned so as to overlap a support substrate 50, and in this state, one region of a silicone sheet 51 that has been heated and expanded is bonded to an end of the plastic substrate 32, and the other region of the silicone sheet 51 is bonded to the support substrate 50. Thus, the plastic substrate 32 is supported on the support substrate 50 by a biasing force of the silicone sheet 51. Then, thin films, such as color filter layers 30 and a counter electrode 31, are formed over the plastic substrate 32 supported on the support substrate 50. Thereafter, the end of the plastic substrate 32, to which the silicone sheet 51 has been bonded, is cut off by laser light radiation to separate the counter substrate 14 from the support substrate 50.

In the subsequent bonding step, the active matrix substrate 13 and the counter substrate 14 are bonded to each other. First, the sealant 29 is formed substantially in a frame shape in a frame region on the alignment film 17, 27 side of the active matrix substrate 13 or the counter substrate 14. At this time, the sealant 29 is formed so that an injection hole for injecting a liquid crystal material therethrough is formed when the active matrix substrate 13 and the counter substrate 14 are bonded to each other. Then, the active matrix substrate 13 and the counter substrate 14 are bonded via the sealant 29 so that their respective surfaces, which are respectively provided with the alignment films 17, 27, face each other. Then, a liquid crystal material is injected through the injection hole, and the injection hole is sealed, thereby forming the liquid crystal layer 15.

Then, the polarizers 18, 28 are respectively bonded to the respective surfaces located on the side opposite to the liquid crystal layer 15 side of the active matrix substrate 13 and the counter substrate 14, thereby fabricating the LCD panel 11. Then, the backlight 12 is provided, whereby the LCD device 10 is completed.

The method for manufacturing the display device according to the present preferred embodiment of the present invention includes the first step of preparing the plastic substrate 19 placed on the support substrate 50; the second step of bonding one region 61 of the expanded silicone sheet 51 to the end 55 of the plastic substrate 19 placed on the support substrate 50, and bonding the other region 62 of the silicone sheet 51 to the support substrate 50 having the plastic substrate 19 placed thereon, thereby fixing the plastic substrate 19 to the support substrate 50 by the biasing force of the silicone sheet 51; and the third step of laminating a plurality of thin films over the plastic substrate 19 fixed to the support substrate 50.

According to this configuration, since the end 55 of the plastic substrate 19 is fixed to the support substrate 50 by the biasing force of the silicone sheet 51, excellent flatness of the plastic substrate 19 can be ensured even in the step of laminating thin films, which requires a high temperature treatment, or a treatment with a chemical or the like. This can satisfactorily reduce the problem of non-uniform quality of the thin films, which is caused by bending of the substrate and a change in dimensions of the substrate. Moreover, uniformly controlling a change in dimensions of the plastic substrate 19 can reduce generation of static electricity, whereby the quality of the films to be formed and etching can be stabilized. Moreover, a normal apparatus that merely has the support substrate 50 can be used as it is to process the plastic substrate 19 that is easily bent. Thus, a high-performance thin film laminated device can be formed over the plastic substrate 19 with satisfactory manufacturing efficiency at satisfactory manufacturing cost.

Note that, although the support substrate 50 preferably is a glass substrate in the present preferred embodiment, the present invention is not limited to this. The support substrate may be a metal substrate, a ceramic substrate, a resin substrate, or the like.

Although the active matrix substrates 13 and the counter substrate 14 of the LCD device 10 preferably are respectively formed by the plastic substrates 19, 32, the present invention is not limited to this. It is only required that at least one of the active matrix substrate 13 and the counter substrate 14 be formed by the plastic substrate 19, 32.

Although the gate electrode 21, the source electrode 25, and the drain electrode 26 are preferably made of Ti, the present invention is not limited to this. The gate electrode 21, the source electrode 25, and the drain electrode 26 may be made of, e.g., Al, Mo, MoW, MoNb, an Al alloy, Ta, ITO, or the like.

Although the elastic member preferably is defined by the silicone sheet 51, the present invention is not limited to this. The elastic member may be a polytetrafluoroethylene-based sheet. In particular, in the case where the surface of the polytetrafluoroethylene-based sheet, which is bonded to the plastic substrate 19 and the support substrate 50, is a mirror like surface, the polytetrafluoroethylene-based sheet can be satisfactorily bonded to the plastic substrate 19 and the support substrate 50. Moreover, the elastic member may be anything that is elastic, and is strong enough to be able to maintain the state where the plastic substrate 19 is supported on the support substrate 50, during the manufacturing process.

The elastic member is preferably expanded by heating, and bonded to the plastic substrate 19 and the support substrate 50. However, the elastic member need not necessarily be expanded by heating. The elastic member may be electrically or mechanically expanded by a piezoelectric element, and bonded to the plastic substrate 19 and the support substrate 50.

Although the respective ends of the active matrix substrate 13 and the counter substrate 14, to which the silicone sheet 51 has been bonded, are preferably cut off by laser light radiation, the present invention is not limited to this. The respective ends of the active matrix substrate 13 and the counter substrate 14 may be cut off by, e.g., a dicing apparatus or the like.

Although an LCD device is described as an example of the display device in the above preferred embodiments, the present invention is not limited to this. The display device may be, e.g., an electroluminescence display device, a plasma display device, an electrochromic display device, a field emission display, or the like.

As described above, the present invention is useful for methods for manufacturing a display device, and display devices.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-16. (canceled)

17. A method for manufacturing a display device, comprising:
a first step of preparing a plastic substrate on a support substrate;
a second step of bonding a first region of an expanded elastic member to an end of the plastic substrate on the support substrate, and bonding a second region of the elastic member to the support substrate having the plastic substrate thereon, thereby fixing the plastic substrate to the support substrate by a biasing force of the elastic member; and
a third step of laminating a plurality of thin films over the plastic substrate fixed to the support substrate.

18. The method of claim 17, wherein the elastic member has a hardness of 60° or less as measured by a type A durometer as specified in JIS K 6253.

19. The method of claim 17, wherein in the second step, the elastic member is expanded by heating.

20. The method of claim 19, wherein the plastic substrate and the support substrate are also expanded by heating to the same temperature as that of the elastic member, and in this state, the second region of the elastic member is fixed to the support substrate.

21. The method of claim 19, wherein in the second step, the elastic member is heated at a temperature equal to or higher than a highest temperature at which the plastic substrate is heated when the plurality of thin films are laminated in the third step.

22. The method of claim 17, wherein in the first step, a treatment for reducing friction is performed on a surface of the support substrate, which faces the plastic substrate, and/or a surface of the plastic substrate, which faces the support substrate.

23. The method of claim 22, wherein the treatment for reducing friction, which is performed on the support substrate, is a process of forming a concavo-convex pattern in which a difference in height between a concave portion and a convex portion is about 1 μm to about 10 μm.

24. The method of claim 22, wherein the treatment for reducing friction is a process of forming an inorganic film.

25. The method of claim 22, wherein the treatment for reducing friction is a process of forming a concavo-convex pattern by photolithography.

26. The method of claim 22, wherein the treatment for reducing friction is a process of applying a low friction material.

27. The method of claim 17, wherein in the first step, a treatment for reducing static electricity is performed on a surface of the support substrate, which faces the plastic substrate, and/or a surface of the plastic substrate, which faces the support substrate.

28. The method of claim 27, wherein the treatment for reducing static electricity is a process of forming a conductive film.

29. The method of claim 28, wherein the conductive film includes a transparent conductive member.

30. The method of claim 29, wherein the transparent conductive member is made of ITO or IZO.

31. The method of claim 17, further comprising:
a fourth step of cutting off an end of the plastic substrate, to which one region of the elastic member has been bonded, by laser light radiation after the plurality of thin films are laminated over the plastic substrate in the third step.

32. A display device manufactured by the method of claim 17.
